(19) United States
(12) Patent Application Publication
(10) Pub. No.: US 2024/0113881 A1
(43) Pub. Date: Apr. 4, 2024

(54) AUTHORIZED USERS AND EXPERIENCES AUTHENTICATED/MANAGED BY NON-FUNGIBLE TOKEN (NFT) OWNERSHIP

(71) Applicant: Capital One Services, LLC, McLean, VA (US)

(72) Inventors: Imren JOHAR, Clifton, VA (US); Dennis Sean BRENNAN, Pleasanton, CA (US); Kevin OSBORN, Newton Highlands, MA (US)

(73) Assignee: Capital One Services, LLC, McLean, VA (US)

(21) Appl. No.: 17/937,964

(22) Filed: Oct. 4, 2022

(51) Int. Cl. H04L 9/32; H04L 9/08

(52) U.S. Cl. CPC H04L 9/3213; H04L 9/0825; H04L 2209/603

(57) ABSTRACT

Methods and systems are described herein for authorizing limited user access to resources of other users using NFTs. A resource access system may be used to authorize access. The system may receive a first request for performing an action using a resource associated with a first user, and in response to the first request, obtain an encrypted payload from a blockchain node of a blockchain. The system may transmit a command to the second device to decrypt the encrypted payload using the second cryptography-based storage application and receive the access token and the one or more access parameters from the second device. In response to determining that metadata of the first request matches the one or more access parameters of the access token, the system may transmit a request to perform the action.

### BACKGROUND

Performing actions associated with one's resources, such as transferring or using personal data and assets, can be core functions. To ensure that only the appropriate owner of these resources is performing actions, users may be required to be authenticated. For example, to prevent theft or abuse of one's resources, users may be required to complete authentication processes in order to perform many types of actions (e.g., accessing and using the resources, etc.). Thus, many platforms use conventional authentication processes, such as passwords, personal identification numbers (PINs), biometric data, etc. before allowing users to perform actions associated with their resources. However, when the owner of a resource wishes to delegate the ability to perform certain actions associated with the resources to others (e.g., provide limited access to on-demand videos, allow a user to borrow lab equipment a number of times, etc.) without giving away complete control of the resources, a more complex authentication process may be required in order to prevent security breaches. The above-mentioned processes (e.g., passwords, PINs, etc.) may work well for large institutions or other entities because those institutions may have the resources to support servers and networks needed for those processes. However, they may not work well for individual users because users do not possess the resources to maintain servers and for hosting authentication systems to access data. Accordingly, a mechanism is disclosed that would enable both individuals and institutions to provide limited access to resources without the need to maintain such large infrastructure.

### SUMMARY

One mechanism to enable both users and institutions to authorize limited user access to resources of other users may use blockchain technology and, in particular, cryptographic tokens (e.g., non-fungible tokens, also known as NFTs). Therefore, methods and systems are described herein for authorizing limited user access to resources (e.g., assets, data, videos, equipment, etc.) of other users (e.g., owners of the resources) using cryptographic tokens (e.g., NFTs). The cryptographic tokens may include an encrypted payload storing an access token that allows a user to perform actions associated with one or more access parameters (e.g., time parameters, location parameters, etc., that may limit another user's access) or may alternatively include a resource identifier identifying the encrypted payload or a location of the encrypted payload (e.g., which may be stored at a database or on the system itself). A resource access system may be used to perform operations described herein.

The cryptographic tokens may be used by the resource access system as described below. The resource access system may receive a blockchain operation request from a user device (e.g., the user who is being enabled by the owner of the resource to perform the action) for performing an action using a resource associated with a first user. The blockchain operation request may include an identifier of a cryptographic token. For example, the blockchain operation request may include the identifier of an NFT described above. In addition, as described above, the cryptographic token may be associated with an encrypted payload that stores an access token and one or more access parameters. The encrypted payload may have been encrypted using a key (e.g., a private key) associated with the second cryptography-based storage application. In response to the request, the resource access system may obtain the encrypted payload and may transmit a command to the second device to decrypt the encrypted payload using the second cryptography-based storage application. The resource access system may receive the access token and the one or more access parameters from the second device and may transmit a request to perform the action. For example, the resource access system may transmit the request to a computing device associated with the resource. In another example, the resource access system may transmit the request to the user device that requested access so that the user device is able to submit the request to the computing device.

To use the cryptographic token as described, above the resource access system may first cause the cryptographic token to be generated. The resource access system may receive a blockchain operation request from a first user's device for enabling performance of one or more actions using a resource of the first user by a second user. The blockchain operation request may include a target address associated with a cryptography-based storage application of the second user and one or more access parameters that indicate one or more limits on access to the resource. For example, a video provider may allow access to the on-demand video for certain periods of time and not for other periods, or a limited number of times. Using the access parameters and the target address, the resource access system may generate an access token for enabling limited access to the resource of the first user. In one example, the access token may be encrypted into an encrypted payload using a public key associated with a cryptography-based storage application associated with the second user (a user that will access the resource). Further, the resource access system may generate a blockchain operation request to be executed by a blockchain node for generating a cryptographic token containing the encrypted payload (e.g., storing the access token) and may transmit the blockchain operation request to a blockchain node to commit, using an on-chain program, the NFT to a blockchain.

The above-described mechanism may perform the following operations to authorize limited user access to resources. The resource access system may receive a request from a first device for enabling performance of an action related to a resource. In particular, the resource access system may receive a request for enabling performance of an action for a resource of a first user of a first device corresponding to a first cryptography-based storage application using the second device (e.g., of a second user associated with a second cryptography-based storage application). For example, a system may receive a request from a video provider to enable access to an on-demand video to a second user. The request may include one or more access parameters that may indicate one or more limits on access to the resource and a target address of the second cryptography-based storage application. For example, the access parameters may indicate a limited number of times a user may access the video, when a user may access the video, etc.

The resource access system may generate an access token based on the one or more access parameters. The access token may enable limited access to the resource of the first user. In some embodiments, the resource access system may use encryption to further secure the access token. In particular, the resource access system may determine, based on the target address, a key (e.g., a public key) associated with the second cryptography-based storage application (e.g., of the second user) and encrypt the access token. The encryption may yield an encrypted payload that may be decrypted using, for example, a private key associated with the second cryptography-based storage application.

The resource access system may generate a blockchain operation request to be executed by the blockchain node for generating the cryptographic token containing the encrypted payload and transmit the blockchain operation request to the blockchain node to commit the cryptographic token to the blockchain. The blockchain operation request may include the encrypted payload, and the cryptographic token may be assigned to the second cryptography-based storage application. In another example, the resource access system may generate a resource identifier, such as a Uniform Resource Identifier (URI), for locating the encrypted payload. The resource access system may insert the resource identifier into the NFT and store the encrypted payload at the location indicated by the resource identifier.

In some embodiments, the resource access system may obtain an indication that the blockchain operation was successful. For example, the system may obtain from the blockchain node, an indication of a successful blockchain operation for committing the cryptographic token to the blockchain. Once the system obtains the indication, the system may also alert the second device that the cryptographic token has been committed. The system may transmit, to the second device, a signal indicating the identifier of the cryptographic token. For example, the system may transmit an alert to the second user that the video provider has provided access to the on-demand video.

Once the cryptographic token is committed, the second user may request to perform the action. The resource access system may receive a request for performing an action using a resource of another user. For example, a user may attempt to access an on-demand video using an account. Thus, the access control system may receive a request from the user for accessing the video. In particular, the resource access system may receive, from a second device associated with a second cryptography-based storage application of a second user, a first blockchain operation request for performing an action using a resource associated with a first user. The blockchain operation request may include an identifier of a cryptographic token. In some examples, the cryptographic token may be associated with an encrypted payload that stores an access token and one or more access parameters (e.g., parameters that indicate one or more limits on access to the resource). The encrypted payload may have been encrypted using a key (e.g., a public key) associated with the second cryptography-based storage application.

The resource sharing system may then obtain the encrypted payload from a blockchain node of a blockchain. For example, obtaining the encrypted payload may include transmitting, to the blockchain node, a blockchain operation request to access the cryptographic token. The blockchain operation request may include the identifier of the cryptographic token. The system may receive from the blockchain node, token data associated with the cryptographic token. The token data may include a resource identifier for access to the encrypted payload. The access control system may then extract the resource identifier from the cryptographic token.

The resource access system may also transmit a command to the second device to decrypt the encrypted payload using the second cryptography-based storage application. The command may include the encrypted payload. For example, the second user may be equipped to decrypt the encrypted payload using a private key associated with a second cryptography-based storage application. The resource access system may receive (e.g., back from the second device), the access token and the one or more access parameters (e.g., that limit the second user's access to the resource) (e.g., time parameters, location parameters, etc.). Using the access parameters, the resource access system may determine whether the request for accessing the resources is valid (e.g., within a designated time frame, within a designated location, etc.) and may authorize user access to the resource. In response to determining that the metadata of the first request matches the one or more access parameters, the resource access system may transmit (e.g., to a computing device associated with the resource) a second command to perform the action.

In some embodiments, the resource access system may obtain the one or more access parameters from, for example, the cryptographic token. The access parameters may include one or more mutable parameters having values indicating whether the second device is allowed to perform the action. In response to determining, based on a maximum value of a mutable parameter of the one or more access parameters, that the second device is allowed to perform the action using the resource, the resource access system may transmit a request to perform the action and modify a value of the mutable parameter to match a corresponding value within the first request. For example, the mutable parameters may indicate a number of times the second user is allowed to perform the action. If the value of the mutable parameter is larger than 0, the second user may perform the action via the second device and the value may be updated to indicate that the user has performed the action so the number of times the second user may perform the action may be subsequently decremented.

The resource access system may enable access to the resources by transmitting a request to perform the action. The system may transmit different requests for performing the action based on a resource type. In some examples, the system may determine an associated resource type of the cryptographic token. In response to determining that the cryptographic token is associated with a first resource type, the system may transmit an execution command to perform the action to a computing device corresponding to the resource and receive an indication of successful performance of the action. Alternatively, or additionally, in response to determining that the cryptographic token is associated with a second resource type, the system may transmit the execution command for accessing the resource to the second device. The command may include one or more instructions for using the access token. For example, where the resource type is one of prolonged access, (e.g., access to a video recording, etc.) the execution command may include instructions such as a limit to a time until the user can access the video (e.g., for 1 week, etc.).

In some examples, in order to verify that the second user is in control of the cryptographic token, the system may further transmit, to the blockchain node, a token request for data indicating one or more cryptographic tokens assigned to the second cryptography-based storage application. In some examples, the token request may include an address of the second cryptography-based storage application. The system may then obtain, from the blockchain node, the data indicating the one or more cryptographic tokens assigned to the second cryptography-based storage application. By determining that the identifier associated with the cryptographic token is included in the data indicating the one or more cryptographic tokens assigned to the second cryptography-based storage application, the resource access system may determine that the second cryptography-based storage application controls with the cryptographic token identified in the request.

Various other aspects, features, and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for authorizing limited user access to resources of other users using NFTs, in accordance with one or more embodiments of this disclosure.

FIG. 2 illustrates a portion of a data structure for a request for performing an action using the resource associated with the first user, in accordance with one or more embodiments of this disclosure.

FIG. 3 illustrates a portion of a data structure representing a cryptographic token, in accordance with one or more embodiments of this disclosure.

FIG. 4 illustrates a portion of a data structure for a request for enabling performance of an action related to a resource associated with a first user, in accordance with one or more embodiments of this disclosure.

FIG. 5 is an illustrative diagram for a decentralized environment for performing blockchain functions, in accordance with one or more embodiments.

FIG. 6 illustrates a computing device, in accordance with one or more embodiments of this disclosure.

FIG. 7 is a flowchart of operations for performing an action using a resource associated with a first user, in accordance with one or more embodiments of this disclosure.

FIG. 8 is a flowchart of operations for enabling performance of an action related to a resource associated with a first user, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

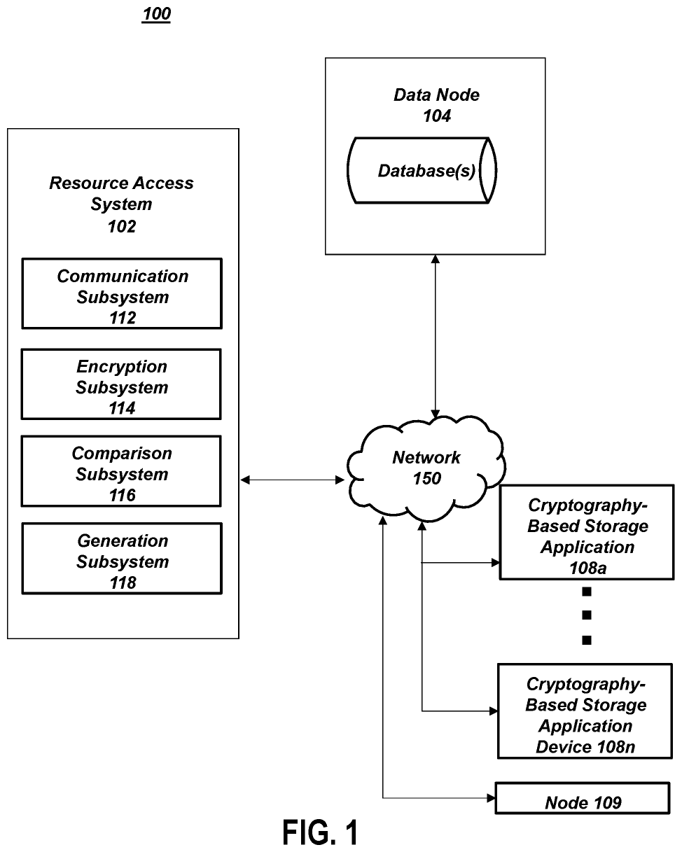

FIG. 1 is an example of environment 100 for authorizing limited user access to resources of other users using NFTs. For example, environment 100 may be used to authorize and perform actions associated with resources of a user, such as allowing limited access to an on-demand video of a video provider. Environment 100 includes resource access system 102, data node 104, cryptography-based storage applications 108a-108n, and node 109. Resource access system 102 may execute instructions for authorizing limited user access to resources of other users using NFTs.

Resource access system 102 may include software, hardware, or a combination of the two. For example, resource access system 102 may be hosted on a physical server or a virtual server that is running on a physical computer system. In some embodiments, resource access system 102 may be configured on a user device (e.g., a laptop computer, a smartphone, a desktop computer, an electronic tablet, or another suitable user device). Resource access system 102 may be in communication (e.g., via network 150) with a node contributing to a blockchain and which may execute operations on a blockchain node, such as node 109. Node 109 may be any computer or processor configured to run a blockchain's software and to validate and store transactions on the network.

Data node 104 may store various data, including user data, copies of on-chain programs, and/or other suitable data. Data node 104 may include software, hardware, or a combination of the two. For example, data node 104 may be a physical server, or a virtual server that is running on a physical computer system. In some embodiments, resource access system 102 and data node 104 may reside on the same hardware and/or the same virtual server/computing device. Network 150 may be a local area network, a wide area network (e.g., the Internet), or a combination of the two.

Cryptography-based storage applications 108a-108n may include software, hardware, or a combination of the two. For example, each cryptography-based storage application may include software executed on one or multiple devices or may include hardware such as a physical device. In some cases, the cryptography-based storage application may be software and may be stored in user devices (e.g., client devices such as smartphone, laptops, electronic tablets, etc.), and a user of the cryptography-based storage application may access the cryptography-based storage application on those devices. Alternatively, or additionally, the cryptography-based storage application may reside on a special device (e.g., a fob) intended for storing the cryptography-based storage application. For example, the device may store private keys in a memory of the device and allow transactions to be signed (e.g., via generating a cryptographic signature) on the device itself. Examples of cryptography-based storage applications may include cryptographic wallets. For example, the cryptography-based storage application may include a digital wallet (e.g., hot wallet, cold wallet, etc.). As described herein, some examples of hardware cryptographic wallets include Ledger®, and Trezor®. Software cryptographic wallets may include Metamask® and others.

Resource access system 102 may receive requests to authorize limited user access to resources of other users (e.g., using NFTs). For example, resources may include financial resources (e.g., financial assets, credit line, bank account, etc.), digital media (e.g., photos, on-demand videos, documents, etc.), and/or the like. Requests to authorize limited user access may include for example, requests for performing an action using a resource associated with another user (e.g., a second user may request to perform an action with the resource of a first user) and/or requests for enabling performance of the action related to the resource (e.g., the first device may request to enable the second device to perform the action). In some embodiments, resource access system 102 may receive the requests using communication subsystem 112.

Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive one or more requests to enable access to user data and/or one or more requests for accessing user data from one of cryptography-based storage applications 108a-108n. Communication subsystem 112 may pass at least a portion of the data included in the requests to authorize limited access, or a pointer to the data in memory, to other subsystems such as generation subsystem 118, comparison subsystem 116, and/or encryption subsystem 114.

Encryption subsystem 114 may include software components, hardware components, or a combination of both. Encryption subsystem 114 may be used to encrypt data, such as resource identifiers, access parameters, access tokens, etc., for example, using a public or private key associated with the cryptography-based storage application of the second user (e.g., the user associated with the device that will be performing the action) to obtain an encrypted payload. Encryption subsystem 114 may pass at least a portion of the encrypted payloads, or a pointer to the encrypted payloads in memory, to other subsystems, such as generation subsystem 118, comparison sub system 116, and/or communication sub system 112.

Comparison subsystem 116 may include software components, hardware components, or a combination of both. Comparison subsystem 116 may be used to compare one or more aspects of blockchain operations and/or the cryptographic token to access parameters, as described herein. Comparison subsystem 116 may pass at least a portion of data, for example, data indicating whether metadata of a request (e.g., requests having exemplary data structure 200 and exemplary data structure 400 described herein) match the one or more access parameters, or a pointer to the data in memory, to other subsystems, such as generation subsystem 118, comparison subsystem 116, and/or communication sub system 112.

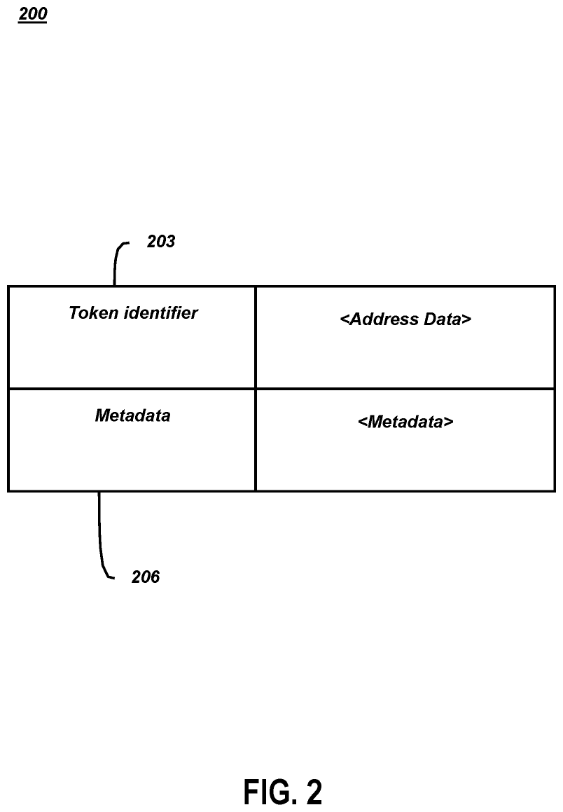

Generation subsystem 118 may include software components, hardware components, or a combination of both. For example, generation subsystem 118 may include software components (e.g., API calls) that access and/or execute programs such as on-chain programs to generate tokens (e.g., cryptographic tokens). Generation subsystem 118 may access the data included in the request to enable performance of the action, for example, in memory. In some embodiments, the request data may include an identifier for an on-chain program for generating a token for enabling access, the target address associated with the second cryptography-based storage application, and/or the like. An on-chain program may be a computer program or any suitable code for performing computing operations stored on a blockchain. For example, an on-chain program may reference a program stored on a blockchain, or other distributed ledger. They may be used to automate the execution of a transaction, such as a blockchain operation. In another example, an on-chain program may refer to a smart contract. In some cases, the on-chain program may run when predetermined conditions are satisfied. In one example, the on-chain program may be a smart contract deployed on a blockchain. Components of the request for enabling access to the user data are described further herein with reference to FIG. 2.

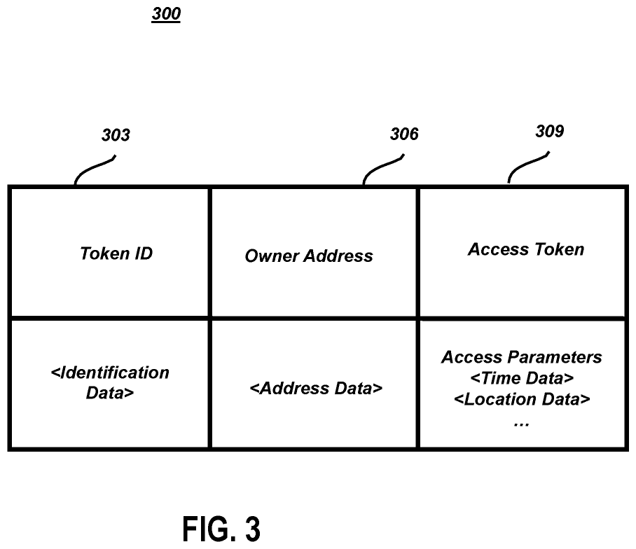

FIG. 2 illustrates an exemplary data structure 200 for a request for performing an action using the resource associated with the first user. Exemplary data structure 200 for a request for performing the action may include token identifier 203 and metadata 206. Token identifier 203 may store data identifying a token, such as a cryptographic token (e.g., NFT). An exemplary cryptographic token is described herein with reference to FIG. 3.

The token identifier 203 may be an identifier (e.g., an address of the on-chain contract that generated the token, a unique identifier of the token, etc.). In some examples, the token identifier may indicate a string of alphanumeric characters, such as a unique identification number. For example, where a second user associated with a second cryptography-based storage application (e.g., 108n) requests to perform an action using a resource of a first user access to the first user's resource, the request may include the token identifier to identify a cryptographic token (e.g., NFT) that is associated with an encrypted payload that stores an access token and one or more access parameters. In some examples, token identifier 203 may be a string of alphanumeric characters. For example, token identifier 203 may be a string of 256 alphanumeric characters and may identify an NFT (e.g., a unique uint256 ID inside an on-chain contract associated with the token).

Resource access system 102 may use token identifier 203 to retrieve at least part of the generated cryptographic token. For example, resource access system 102 may obtain the encrypted payload from the blockchain node by transmitting, to a blockchain node (e.g., node 109, and/or the like), a blockchain operation request to access the cryptographic token. The blockchain operation request may include the token identifier 203 of the cryptographic token. In response, resource access system 102 may receive from the blockchain node, token data associated with the cryptographic token.

As described herein, the encrypted payload may store an access token and one or more access parameters. For example, the encrypted payload may store the encrypted access token into the encrypted payload using a key (e.g., public key) associated with the second cryptography-based storage application. In some examples, one or more access parameters of the access token may be encrypted. In some examples, the access token may be a data structure that is encrypted in part or as a whole. In some embodiments, the access token may be a combination of a username and a password to access a particular resource. The access token may also include specific encoding or formatting enabling the user to login to the system. Access parameters may include parameters that limit access to the resource and/or service. In the banking example, access parameters may include a limit on an amount of money that may be transferred and/or a limit on a number of transactions. In the on-demand video example, the access parameters may be a limit on an amount of time for using the service or a number of logins. In another example, an access parameter may be a location (e.g., in a form of a geofence) inside of which access is granted. For example, a function (e.g., Rivest-Shamir-Adleman (RSA) function) may be applied to a message (or the hash of a message), such as the access token, with the public key of the second cryptography-based storage application belonging to the second user. The resource access system 102 may request that the second device decrypt the encrypted payload (e.g., using the private key of the second cryptography-based storage application). Any suitable functions and/or alternative digital signature schemes may be used, such as Probabilistic Signature Scheme (PSS) and/or the like.

In some embodiments, the token data may include a resource identifier of the encrypted payload. For example, the cryptographic token may include a resource identifier (e.g., a URI, etc.) identifying a location where the encrypted payload is stored. The resource access system may extract the resource identifier from the cryptographic token.

As such, in order to verify that the second cryptography-based storage application is the cryptography-based storage application that the first user intended to enable limited access to, resource access system 102 may transmit a command to the second device to decrypt the encrypted payload using the second cryptography-based storage application. The command may include the encrypted payload. In some embodiments, because the access token and access parameter(s) were encrypted using the public key associated with the second cryptography-based storage application, the encrypted payload may only be decrypted using a private key of the same second cryptography-based storage application. Once the second cryptography-based storage application (e.g., 108n) has completed decryption of the encrypted payload (e.g., to yield the access token and one or more access parameters) the second device may transmit the payload (e.g., storing the access token and access parameters). Resource access system 102 may receive the access token and the one or more access parameters from the second device (e.g., via network 150).

According to some embodiments, the second user may be permitted to perform an action using a resource associated with a first user under conditions defined in the access parameters. For example, resource access system 102 may compare the access parameters 403 in the cryptographic token identified by token identifier 203 and parts of the metadata 206 of the request to perform the action (e.g., using comparison subsystem 116). In one particular example, the comparison subsystem 116 of resource access system 102 may determine from metadata 206 that the request to access the data was made at 4:30 p.m. and determine that it falls within the times specified in the access parameters. In some embodiments, resource access system 102 may use the Internet Protocol (IP) address to determine the location of the second device and compare that location with allowed locations to determine whether access to the first user data should be enabled. Resource access system 102 may transmit a request to perform the action in response to determining that metadata of the first request matches the one or more access parameters of the access token.

In some examples, resource access system 102 may determine whether the second device is allowed to perform the action based on a maximum value of a mutable parameter. For example, the mutable parameters may indicate a number of times the second user is allowed to perform the action (e.g., a total of 5 times, once a week, etc.). If the value of the mutable parameter is larger than 0, the resource access system may determine that the second user is allowed to perform the action, for example, via the second device and the value may be updated to indicate that the user has performed the action so the number of times the second user may perform the action may be subsequently decremented. In response to determining, based on a maximum value of a mutable parameter of the one or more access parameters, that the second device is allowed to perform the action using the resource, the system may transmit a request to perform the action and modify a value of the mutable parameter to match a corresponding value within the first request.

In some examples, the command may differ based on the type of resource and the type of resource may be indicated by different associated resource types of the cryptographic token. For example, resource access system 102 may determine an associated resource type of the cryptographic token. If the resource access system determines that the token is associated with a first resource type, the system may transmit an execution command to perform the action to a computing device corresponding to the resource in response. When the action is performed successfully (e.g., by the second device), the resource access system may receive an indication of successful performance of the action (e.g., via network 150). If the resource access system determines that the token is associated with a second resource type, the system may transmit an execution command for accessing the resource to the second device, where the command includes one or more instructions for using the access token. For example, the first resource type may be for an action that a user may complete once, such as a transaction. By contrast, the second resource type may be a time-limited resource, where a user may only perform the action during a specific time (e.g., watching a video until a certain date, etc.). In this example, the one or more instructions may include a time during which the second device may perform the action.

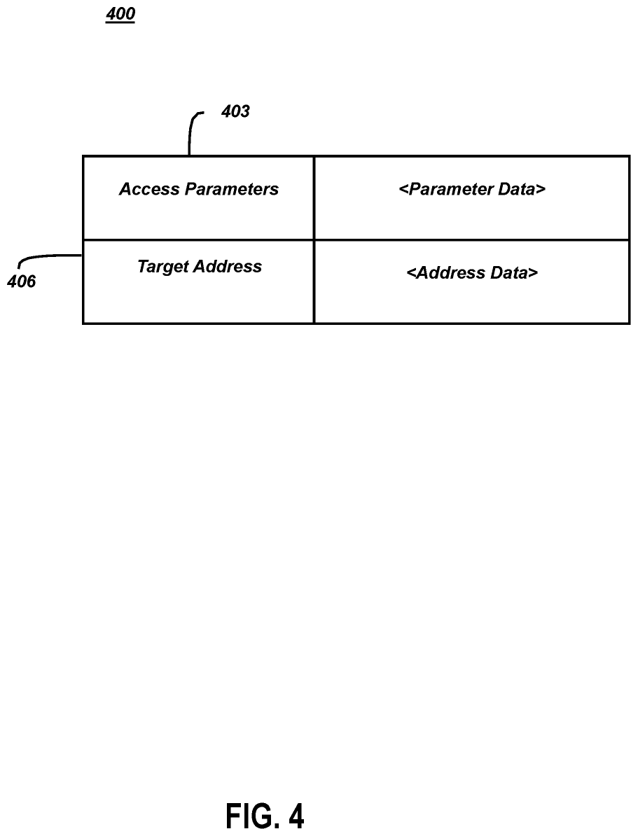

According to some embodiments, the token identified by token identifier 203 may be a cryptographic token, such as one having data structure 300. For example, such a cryptographic token may be generated in response to a first user's request to enable performance of an action by the second user/second device, described in detail with reference to FIG. 4. FIG. 3 illustrates a data structure 300 representing a cryptographic token generated by generation subsystem 118. Data structure 300 may include token identifier 303, owner address 306, and access token 309. Token identifier 303 may be an identifier for the cryptographic token. Token identifier 303 may have a value such as an unsigned integer value from 8 bits to 256 bits. In some embodiments, the term owner address refers to an address associated with a cryptography-based storage application that is able to transfer the cryptographic token by signing a blockchain operation (e.g., a blockchain transaction) with a private key associated with the cryptography-based storage application.

Owner address 306 may have a value identifying the owner of the token. In some examples, generation subsystem 118 may insert a target address into the cryptographic token such that the owner address 306 of the generated cryptographic token contains the target address (e.g., a string of alphanumeric characters, a wallet address, etc.) to a second cryptography-based storage application. In some examples, the target address may be a string of alphanumeric characters. For example, the target address may be a string of 32 alphanumeric characters and may identify what is sometimes referred to as a cryptographic wallet (e.g., a digital wallet). Some examples of hardware cryptographic wallets include Ledger®, and Trezor®. Software cryptographic wallets may include Metamask® and others. The target address may be one that is identified in the request from the first user, for example, target address 406 of exemplary data structure 400 to enable performance of the action.

As described herein, generation subsystem 118 may also generate and insert access token 309 into the cryptographic token. The access token may include one or more parameters that enable access to the first user data. For example, the one or more parameters may specify conditions under which the second user may access the first user data via the second cryptography-based storage application. Some examples of parameters include time-based parameters, such as time limits as to when a second user can access the first user data. For example, the first user may enable the second user to access the first user data only during weekdays, or during certain times of day, such as from 8:00 a.m. to 5:00 p.m. In another example, a time parameter may be an expiration time after which the first user data may not be accessed. Some parameters may include location-based parameters, such as enabling access only in certain areas, or restricting access in certain areas. For example, the first user may enable access to the first user data only in certain countries or states. In another example, a location parameter may indicate that only IP addresses from a particular entity (e.g., a particular hospital or doctor's office) may be allowed access. Other examples of parameters may include a maximum number of times an action may be performed. In some examples, the parameters may be encrypted (e.g., using the public key associated with the second cryptography-based storage application). The encrypted parameters may form an encrypted parameter set.

Generation subsystem 118 of resource access system 102 may generate the access token. According to some examples, the access token may be generated based on one or more of the access parameters (e.g., data indicating the access parameters may be stored within the token). The access token may be inserted into the cryptographic token. In some embodiments, the access token and/or one or more access parameters may be encrypted (e.g., by encryption subsystem 114). For example, encryption subsystem 114 may encrypt the access token using a public key associated with the cryptography-based storage application of the second user (e.g., the user associated with the device that will be performing the action) to obtain an encrypted payload. On receiving the encrypted resource identifier, for example, from resource access system 102, the user (e.g., the second user) may decrypt the encrypted resource identifier, for example, by using a private key associated with the second cryptography-based storage application.

In alternate embodiments, rather than inserting the access token or an encrypted payload storing the access token, a cryptographic token represented by data structure 300 may include a resource identifier identifying a location for the encrypted payload storing the access token. For example, generation subsystem 118 may generate a resource identifier for locating the encrypted payload. The resource identifier may be associated with the first cryptography-based storage application. Generation subsystem 118 may then insert the resource identifier into the cryptographic token represented by data structure 300 and store the encrypted payload at a location indicated by the resource identifier (e.g., at data node 104).

According to some embodiments, the resource identifier may be encrypted. For example, the resource identifier may be encrypted using a public key associated with the cryptography-based storage application of the second user (e.g., the user associated with the device that will be performing the action). On receiving the encrypted resource identifier, for example, from resource access system 102, a user device (e.g., of the second user associated with the second cryptography-based storage application) may decrypt the encrypted resource identifier, for example, by using a private key associated with the second cryptography-based storage application.

In some embodiments, the resource identifier may be a URI. The resource identifier may include a link, a pointer, for example, to a data node 104, and/or the like. In some examples, the resource identifier may be encrypted (e.g., an encrypted URI). In some examples, the access token may be partially or wholly included in metadata, such as private metadata including embedded secret links and/or pointers that cause the action to be performed. In some examples, the resource identifier may include a reference to a location on a third-party platform (e.g., website, application, etc.) allowing access to the resource.

When a cryptographic token is generated by generation subsystem 118, communication subsystem 112 may transmit one or more notifications to the users. For example, communication subsystem 112 may transmit a message (e.g., email, text, etc.) to a device of the first user and/or second user to notify them that the second user may now perform the action. The message may include a link to the second user's cryptography-based storage application or a link to open an application storing the second user's cryptography-based storage application so that the second user may subsequently request to perform the action.

As described herein, the cryptographic token, e.g., represented by data structure 300, may be generated in response to a request by a first user (e.g., a computing device of the first user) to enable performance of the action related to the resource using the second device. FIG. 4 illustrates an exemplary data structure 400 for a request for enabling performance of the action related to the resource using the second device (e.g., a request to mint a cryptographic token). Exemplary data structure 400 may include access parameters 403 and target address 406. As described herein, resource access system 102 may receive a request, for example, from a first user at a first device and/or a first cryptography-based storage application via communication subsystem 112. The request may include data for fields such as access parameters 403 and target address 406.

Access parameters 403 may indicate one or more limits on access to a resource. For example, when the first user requests to enable performance of the action related to the resource, the first user may also indicate limits to specify a number of times an action may be performed, for example, at what times and/or locations the second user action may be performed, and/or the like. In some examples where the resource is a financial asset and the action is a transaction, the access parameters may specify at what institutions the transaction may be performed or a value amount that may be used/spent. In yet other examples, the timing parameters may indicate an expiration date/time of the access and/or a start date/time of the access. In some examples, access parameters 403 may also indicate the resource of the first user. For example, if a user is enabled to perform the action of spending a monetary amount such as purchasing an item using the account information or credit line of another person, the access parameters may indicate a limit for spending that specifies the monetary amount the user is permitted to spend (e.g., in dollars, tokens, cryptocurrency, etc.). If a user is enabled to perform the action of watching an on-demand video, the access parameters may indicate a number of times the video may be watched.

As described herein, in response to determining that metadata of the first request matches the one or more access parameters, the resource access system may transmit (e.g., to a computing device associated with the resource) a second command to perform the action. In some embodiments, the second command may be generated using the one or more access parameters. For example, the second command may specify a number of times a user is enabled to access or use the resource, an amount of the resource a user is enabled to use, and/or the like

Target address 406 may be an identifier such as an address of a second cryptography-based storage application. For example, where a first user associated with a first cryptography-based storage application (e.g., cryptography-based storage application 108a) requests to enable access to the first user's resource by a second user associated with a second cryptography-based storage application (e.g., 108n), target address 406 may indicate the address of the second cryptography-based storage application. In some examples, target address 406 may be a string of alphanumeric characters. For example, the target address may be a string of 32 alphanumeric characters and may identify what is sometimes referred to as a cryptographic wallet. Some examples of hardware cryptographic wallets include Ledger® and Trezor®. Software cryptographic wallets may include MetaMask® and others. As described herein, target address 406 may be later used to encrypt the access token (e.g., using the public key associated with the target address) and may also be used to define an owner of the cryptographic token (e.g., as the owner address 306 of cryptographic token, e.g., represented by data structure 300).

In some examples, communication subsystem 112, when receiving the request, e.g., represented by exemplary data structure 400, may pass access parameters 403 and/or target address 406 to generation subsystem 118. Additionally, or alternatively, communication subsystem 112 may store the parameters and/or target address in memory and pass a pointer to the data in memory to generation subsystem 118.

Generation subsystem 118 of the resource access system 102 may generate the access token based on the one or more access parameters, where the access token may be used to enable limited access to the resource of the first user. The access token may indicate the resource of the first user and one or more parameters for limiting access to the resource.

According to some embodiments, the access token may be encrypted. For example, generation subsystem 118 may pass the generated access token, or a pointer to the access token in memory, to comparison subsystem 116. The encryption subsystem may encrypt the access token to obtain an encrypted payload that may store an access token and one or more access parameters. For example, the access token may be encrypted using a key (e.g., public key) associated with the second cryptography-based storage application. For example, a function (e.g., RSA function) may be applied to a message (or the hash of a message), such as the access token, with the public key of the second cryptography-based storage application belonging to the second user. The resource access system 102 may request that the second device decrypt the encrypted payload (e.g., using the private key of the second cryptography-based storage application). Any suitable functions and/or alternative digital signature schemes may be used, such as PSS and/or the like.

In some embodiments, the token data may include a resource identifier of the encrypted payload. For example, the cryptographic token may include a resource identifier (e.g., a URI, etc.) identifying a location where the encrypted payload is stored. The resource access system may extract the resource identifier from the cryptographic token.

Generation subsystem 118 may generate a cryptographic token (e.g., using an on-chain program). For example, generation subsystem 118 may generate a blockchain operation for a blockchain node that may call and execute an on-chain program to generate the cryptographic token. As part of the generation process, the on-chain program may insert the target address and the access token into the cryptographic token when executed. Alternatively, or additionally, the on-chain program may insert the target address and the encrypted payload or a resource identifier to the encrypted payload storing the access token. The generated token may also be generated to be controlled by the target address associated with the second cryptography-based storage application. For example, the on-chain program may include the target address 406 as the owner address 306 of the cryptographic token. The on-chain program may commit the cryptographic token (e.g., mint the cryptographic token) to the blockchain via a blockchain operation.

When the cryptographic token has been generated, communication subsystem 112 may transmit one or more notifications to the users. For example, communication subsystem 112 may transmit a message (e.g., email, text, etc.) to a device of the first user and/or second user to notify them that the first user data is now available to be requested by the second user. For example, communication subsystem 112 may obtain, from a blockchain node, such as node 109, an indication (e.g., a signal, notification, etc.) of a successful blockchain operation for committing the cryptographic token to the blockchain. In response to obtaining the indication, resource access system 102, via communication subsystem 112, may transmit, to the second device, a signal indicating the identifier of the cryptographic token. As referred to herein, committing to a blockchain may include adding a transaction and/or adding a unique token (e.g., a token identifying a unique and unchangeable reference to some data) to a block of a blockchain (e.g., assigned to a cryptography-based storage application).

In some examples, resource access system 102 may additionally, or alternatively, transmit (e.g., to the node 109) a token request for data indicating one or more cryptographic tokens assigned to the second cryptography-based storage application. In some examples, the token request may include an address of the second cryptography-based storage application and may be used by the node 109 to obtain data associated with one or more cryptographic tokens assigned to the second cryptography-based storage application. The blockchain node may transmit the data such that resource access system 102 obtains, from the blockchain node, the data indicating the one or more cryptographic tokens assigned to the second cryptography-based storage application. Resource access system 102 may then determine that the identifier associated with the cryptographic token is included in the data indicating the one or more cryptographic tokens assigned to the second cryptography-based storage application, for example, to confirm that the second cryptography-based storage application associated with the second user has control of the cryptographic token.

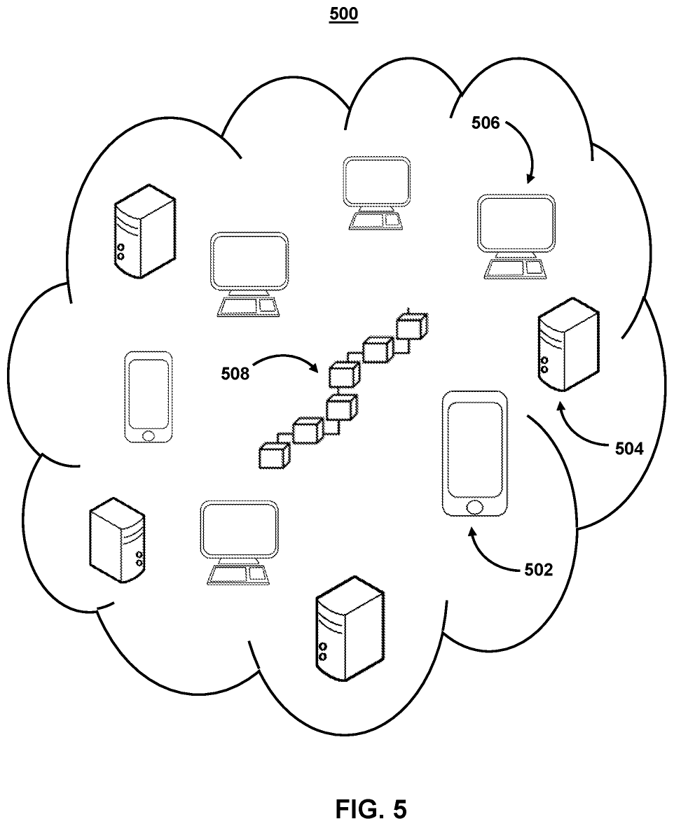

FIG. 5 shows an illustrative diagram for a decentralized environment for performing blockchain functions, in accordance with one or more embodiments. For example, the diagram presents various components that may be used in authorizing limited user access to resources of other users using NFTs in some embodiments.

As shown in FIG. 5, system 500 may include multiple user devices (e.g., user device 502, user device 504, and/or user device 506). For example, system 500 may comprise a distributed state machine, in which each of the components in FIG. 5 acts as a client of system 500. For example, system 500 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system. For example, system 500 may interact with, and facilitate the function of, blockchain 508.

It should be noted that, while shown as a smartphone, a personal computer, and a server in FIG. 5, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments describing the system 500 performing a blockchain function may equally be applied to, and correspond to, an individual user device (e.g., user device 502, user device 504, and/or user device 506) performing the blockchain function. That is, system 500 may correspond to the user devices (e.g., user device 502, user device 504, and/or user device 506) collectively or individually.

Each of the user devices may be used by the system to conduct blockchain functions. As referred to herein, “blockchain functions” may comprise any operations including and/or related to blockchains and blockchain technology. For example, blockchain functions may include conducting transactions, querying a distributed ledger, generating additional blocks for a blockchain, transmitting communications-related NFTs, performing encryption/decryption, exchanging public/private keys, and/or other operations related to blockchains and blockchain technology. In some embodiments, a blockchain function may comprise the creation, modification, detection, and/or execution of a smart contract or program stored on a blockchain. For example, a smart contract may comprise a program stored on a blockchain that is executed (e.g., automatically, without any intermediary's involvement or time loss) when one or more predetermined conditions are met. In some embodiments, a blockchain function may comprise the creation, modification, exchange, and/or review of a token (e.g., a digital blockchain-specific asset), including an NFT. An NFT may comprise a token that is associated with a good, a service, a smart contract, and/or other content that may be verified by, and stored using, blockchain technology.

In some embodiments, blockchain functions may also comprise actions related to mechanisms that facilitate other blockchain functions (e.g., actions related to metering activities for blockchain functions on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain function (e.g., computation, data access, transaction, etc.). Each blockchain function has a predetermined cost in units of gas (e.g., as determined based on a predefined set of rules for the system). When a blockchain function triggers the execution of a smart contract, the blockchain function may include an amount of gas that sets the upper limit of what can be consumed in running the smart contract. The system may terminate execution of the smart contract if the amount of gas consumed by computation exceeds the gas available in the blockchain function. For example, in Ethereum, gas comprises a mechanism for allowing Turing-complete computation while limiting the resources that any smart contract and/or blockchain function may consume.

In some embodiments, gas may be obtained as part of a blockchain function (e.g., a purchase) using a network-specific cryptocurrency (e.g., ether in the case of Ethereum). The system may require gas (or the amount of the network-specific cryptocurrency corresponding to the required amount of gas) to be transmitted with the blockchain function as an earmark to the blockchain function. In some embodiments, gas that is earmarked for a blockchain function may be refunded back to the originator of the blockchain function if, after the computation is executed, an amount remains unused.

As shown in FIG. 5, one or more user devices may include a digital wallet (e.g., digital wallet associated with user device 504) used to perform blockchain functions. A digital wallet may be referred to as a cryptography-based storage application. For example, the digital wallet may comprise a repository that allows users to store, manage, and trade their cryptocurrencies and assets, interact with blockchains, and/or conduct blockchain functions using one or more applications. The digital wallet may be specific to a given blockchain protocol or may provide access to multiple blockchain protocols. In some embodiments, the system may use various types of wallets, such as hot wallets and cold wallets. Hot wallets are connected to the Internet while cold wallets are not. Most digital wallet holders hold both a hot wallet and a cold wallet. Hot wallets are most often used to perform blockchain functions, while a cold wallet is generally used for managing a user account and may have no connection to the Internet.

As shown in FIG. 5, one or more user devices may include a private key and/or digital signature. Digital signature may sometimes be referred to as cryptographic signature. For example, system 500 may use cryptographic systems for conducting blockchain functions, such as for authorizing limited user access to resources of other users using NFTs. For example, system 500 may use public key cryptography, which features a pair of digital keys (e.g., which may comprise strings of data). In such cases, each pair comprises a public key (e.g., which may be public) and a private key (e.g., which may be kept private). System 500 may generate the key pairs using cryptographic algorithms (e.g., featuring one-way functions). System 500 may then encrypt a message (or other blockchain function) using an intended receiver's public key such that the encrypted message may be decrypted only with the receiver's corresponding private key. In some embodiments, system 500 may combine a message with a private key to create a digital signature on the message. For example, the digital signature may be used to verify the authenticity of blockchain functions. As an illustration, when conducting blockchain functions, system 500 may use the digital signature to prove to every node in the system that it is authorized to conduct the blockchain functions.

For example, system 500 may comprise a plurality of nodes for the blockchain network. Each node may correspond to a user device (e.g., user device 502). A node for a blockchain network may comprise an application or other software that records and/or monitors peer connections to other nodes and/or miners for the blockchain network. For example, a miner comprises a node in a blockchain network that facilitates blockchain functions by verifying blockchain functions on the blockchain, adding new blocks to the existing chain, and/or ensuring that these additions are accurate. The nodes may continually record the state of the blockchain and respond to remote procedure requests for information about the blockchain.

For example, user device 502 may request a blockchain function (e.g., conduct a transaction). The blockchain function may be authenticated by user device 504 and/or another node (e.g., a user device in the community network of system 500). For example, using cryptographic keys, system 500 may identify users and give access to their respective user accounts (e.g., corresponding digital wallets) within system 500. Using private keys (e.g., known only to the respective users) and public keys (e.g., known to the community network), system 500 may create digital signatures to authenticate the users.

Following an authentication of the blockchain function, the blockchain function may be authorized. For example, after the blockchain function is authenticated between the users, system 500 may authorize the blockchain function prior to adding it to the blockchain. System 500 may add the blockchain function to blockchain 508. System 500 may perform this based on a consensus of the user devices within system 500. For example, system 500 may rely on a majority (or other metric) of the nodes in the community network (e.g., user device 502, user device 504, and/or user device 506) to determine that the blockchain function is valid. In response to validation of the block, a node user device (e.g., user device 502, user device 504, and/or user device 506) in the community network (e.g., a miner) may receive a reward (e.g., in a given cryptocurrency) as an incentive for validating the block.

To validate the blockchain function, system 500 may use one or more validation protocols and/or validation (or consensus) mechanisms. For example, system 500 may use a Proof of Work (“POW”), mechanism in which a user device must provide evidence that it performed computational work to validate a blockchain function and thus this mechanism provides a manner for achieving consensus in a decentralized manner, as well as preventing fraudulent validations. For example, the POW may involve iterations of a hashing algorithm. The user device that is successful aggregates and records blockchain functions from a mempool (e.g., a collection of all valid blockchain functions waiting to be confirmed by the blockchain network) into the next block. Alternatively, or additionally, system 500 may use a Proof of Stake (“POS”) mechanism in which a user account (e.g., corresponding to a node on the blockchain network) is required to have, or “stake,” a predetermined amount of tokens in order for system 500 to recognize it as a validator in the blockchain network.

### Computing Environment

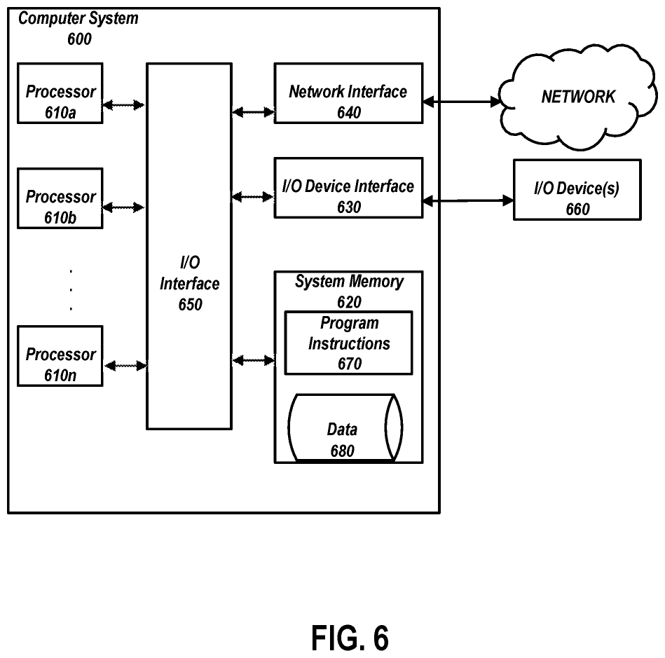

FIG. 6 shows an example computing system that may be used in accordance with some embodiments of this disclosure. In some instances, computer system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computer system 600. Further, processes and modules described herein may be executed by one or more processing systems similar to that of computer system 600.

Computer system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computer system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computer system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example, an FPGA (field-programmable gate array) or an ASIC (application-specific integrated circuit). Computer system 600 may include a plurality of computing devices (e.g., distributed computer systems) to implement various processing functions.

I/O device interface 630 may provide an interface for connection of I/O device(s) 660 to computer system 600. I/O device(s) may include devices that receive input (e.g., from a user) or output information (e.g., to a user). I/O device(s) 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O device(s) 660 may be connected to computer system 600 through a wired or wireless connection. I/O device(s) 660 may be connected to computer system 600 from a remote location. I/O device(s) 660 located on remote computer systems, for example, may be connected to computer system 600 via a network and a network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, read-only memory (ROM), programmable ROM (PROM), erasable PROM (EPROM), electrically EPROM (EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O device(s) 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems (e.g., multiple instances of computer system 600) configured to host different portions or instances of embodiments. Multiple computer systems may provide for parallel or sequential processing/execution of one or more portions of the techniques described herein.

Those skilled in the art will appreciate that computer system 600 is merely illustrative, and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

Operation Flow

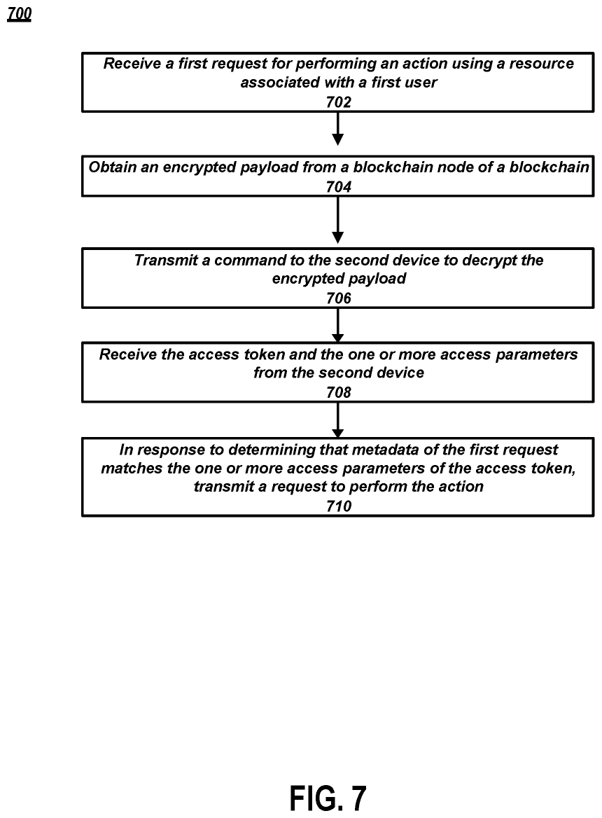

FIG. 7 is a flowchart 700 of operations for authorizing limited user access to resources of other users using NFTs. The operations of FIG. 7 may use components described in relation to FIG. 5 and FIG. 6. In some embodiments, resource access system 102 may include one or more components of system 500 and/or computer system 600.

At 702, resource access system 102 receives a first request for performing an action using a resource associated with a first user. For example, resource access system 102 may receive the first request from a second device, such as through network interface 640 and/or I/O device interface 630 from I/O device(s) 660 (e.g., any of user device 502, user device 504, and user device 506), associated with a second cryptography-based storage application (e.g., cryptography-based storage application 180n) of a second user (e.g., over network 150). According to some examples, the first request may be a request for performing an action using a resource associated with a first user, and may include an identifier of a cryptographic token (e.g., an address associated with the token), wherein the cryptographic token is associated with an encrypted payload that stores an access token and one or more access parameters, and wherein the encrypted payload was encrypted using a key associated with the second cryptography-based storage application. For example, the cryptographic token may be represented by a data structure 300 of FIG. 3.

At 704, resource access system 102 obtains an encrypted payload from a blockchain node of a blockchain (e.g., blockchain 508), for example, in response to the first request. In some examples, the system may obtain the encrypted payload via network interface 640 and/or via I/O device interface 630. According to some examples, resource access system 102 may obtain the encrypted payload by transmitting, to the blockchain node (e.g., a node of blockchain 508), a blockchain operation request to access the cryptographic token. For example, the blockchain operation request may include the identifier of the cryptographic token, such as token identifier 203. Resource access system 102 may then receive from the blockchain node, token data associated with the cryptographic token, wherein the token data comprises a resource identifier of access to the encrypted payload and extract the resource identifier from the cryptographic token.

At 706, resource access system 102 transmits a command to the second device (e.g., any of user device 502, user device 504, and user device 506) to decrypt the encrypted payload. For example, resource access system 102 transmits a command to the second device using the second cryptography-based storage application, and the command may include the encrypted payload. For example, the system may transmit the command via I/O device interface 630 and/or network interface 640. In one embodiment, the encrypted payload may store an access token (e.g., access token 309) and one or more access parameters. For example, the resource access system 102 may encrypt the access token (e.g., access token 309) into the encrypted payload using a key (e.g., public key) associated with the second cryptography-based storage application. For example, a function (e.g., RSA function) may be applied to a message (or the hash of a message), such as the access token, with the public key of the second cryptography-based storage application belonging to the second user. The resource access system 102 may request that the second device decrypt the encrypted payload (e.g., using the private key of the second cryptography-based storage application). Any suitable functions and/or alternative digital signature schemes may be used, such as PSS and/or the like.

At 708, resource access system 102 receives the access token and the one or more access parameters from the second device. For example, resource access system 102 may receive the access token and the one or more access parameters via network 150.

At 710, resource access system 102 transmits a request to perform the action. For example, the request may be represented by exemplary data structure 400. In some examples the request may be transmitted in response to determining that metadata of the request matches the one or more access parameters of the access token (e.g., access token 309). Resource access system 102 may use one or more of processors 610a, 610b, and/or 610n to perform the determination.

In some embodiments, resource access system 102 may determine an associated resource type of the cryptographic token. In response to determining that the cryptographic token is associated with a first resource type, resource access system 102 may transmit an execution command to perform the action to a computing device corresponding to the resource. When the action is performed successfully, resource access system 102 may receive an indication of successful performance of the action. Alternatively, or additionally, resource access system 102 may determine that the cryptographic token is associated with a second resource type. In response to determining that the token is associated with the second resource type, resource access system 102 may transmit the execution command for accessing the resource to the second device, wherein the command includes one or more instructions for using the access token.

In some embodiments, the system may obtain, from the access token, the one or more access parameters. Resource access system 102 may determine, based on a maximum value of a mutable parameter of the one or more access parameters, whether the second device is allowed to perform the action using the resource. In response to determining that the second device is allowed to perform the action, resource access system 102 may modify a value of the mutable parameter to match a corresponding value within the first request.

In some embodiments, resource access system 102 may transmit, to the blockchain node, a token request for data indicating one or more cryptographic tokens assigned to the second cryptography-based storage application. For example, the token request may include an address of the second cryptography-based storage application. Resource access system 102 may obtain, from the blockchain node, the data indicating the one or more cryptographic tokens assigned to the second cryptography-based storage application. Resource access system 102 may determine that the identifier associated with the cryptographic token is included in the data indicating the one or more cryptographic tokens assigned to the second cryptography-based storage application.

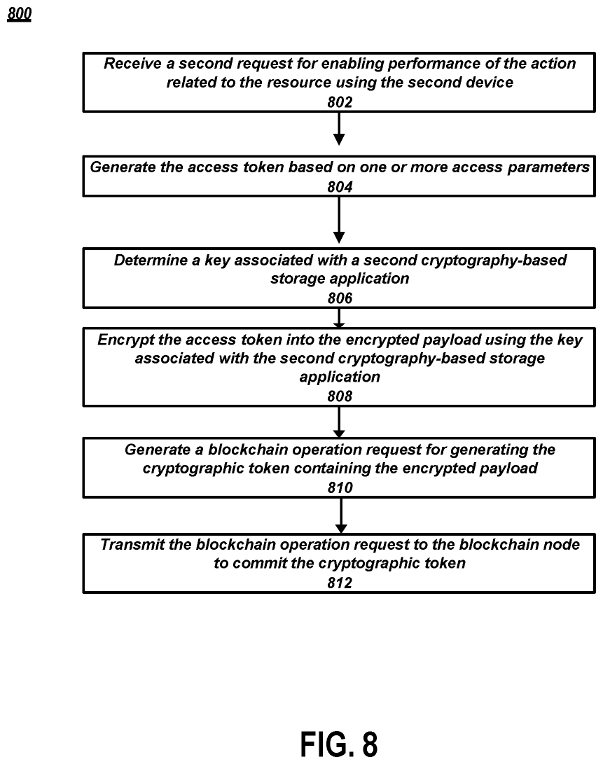

FIG. 8 is a flowchart 800 of operations for authorizing limited user access to resources of other users using NFTs. The operations of FIG. 8 may use components described in relation to FIG. 5 and FIG. 6. In some embodiments, resource access system 102 may include one or more components of system 500 and/or computer system 600.

At 802, resource access system 102 may receive a second request for enabling performance of the action. For example, resource access system 102 may receive the second request from a first device (e.g., I/O device(s) 660) storing a first cryptography-based storage application of the first user (e.g., over network 150). In some examples, the system may receive the second request via network interface 640 and/or I/O device interface 630. According to some examples, the second request may be a request for enabling performance of the action related to the resource using the second device, and may include one or more access parameters (e.g., indicating one or more limits on access to the resource), and/or a target address of the second cryptography-based storage application.

At 804, resource access system 102 may generate the access token based on one or more access parameters, for example, using any of processors 610a-n. The access token may enable limited access to the resource of the first user. In some examples, the access token may also be generated based on a target address of the second user.

At 806, resource access system 102 may determine a key associated with a second cryptography-based storage application. For example, the key may be a public key associated with a cryptography-based storage application of the second user.

At 808, resource access system 102 may encrypt the access token into the encrypted payload. For example, the resource access system 102 may encrypt the access token using the key (e.g., public key) associated with the second cryptography-based storage application (e.g., as determined in 806).

At 810, resource access system 102 may generate a blockchain operation request for generating the cryptographic token containing the encrypted payload, for example, using any of processors 610a-n. Alternatively, or additionally, the resource access system 102 may generate a blockchain operation request (e.g., using processors 610a-n) to be executed by a blockchain node for generating an NFT containing the access token.

At 812, resource access system 102 may transmit the blockchain operation request to the blockchain node, such as a blockchain node of blockchain 508, to commit the cryptographic token. For example, the resource access system 102 may transmit the blockchain operation request to the blockchain node to commit, using an on-chain program, the NFT to a blockchain such as blockchain 508. According to some examples, the blockchain operation request includes the encrypted payload, and the cryptographic token (e.g., NFT) is assigned to the second cryptography-based storage application.

In some embodiments, the resource access system 102 may obtain, from the blockchain node, an indication of a successful blockchain operation for committing the cryptographic token to the blockchain (e.g., via network interface 640 and/or via I/O device interface 630). The resource access system 102 may transmit (e.g., via network interface 640 and/or via I/O device interface 630), to the second device, a signal indicating the identifier of the cryptographic token.

In some embodiments, the resource access system 102 may further generate a resource identifier for locating the encrypted payload, for example, using any of processors 610a-n. In some examples, the resource identifier is associated with the first cryptography-based storage application (e.g., cryptography-based storage application 108a). The resource access system 102 may also insert the resource identifier into the cryptographic token and store the encrypted payload at a location indicated by the resource identifier, for example, using any of processors 610a-n.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for authorizing limited user access to resources of other users using NFTs, the method comprising: receiving, from a second device associated with a second cryptography-based storage application of a second user, a first request for performing an action using a resource associated with a first user, the first request comprising an identifier of a cryptographic token, wherein the cryptographic token is associated with an encrypted payload that stores an access token and one or more access parameters, and wherein the encrypted payload was encrypted using a key associated with the second cryptography-based storage application; in response to the first request, obtaining the encrypted payload from a blockchain node of a blockchain; transmitting a command to the second device to decrypt the encrypted payload using the second cryptography-based storage application, wherein the command comprises the encrypted payload; receiving the access token and the one or more access parameters from the second device; and in response to determining that metadata of the first request matches the one or more access parameters of the access token, transmitting a request to perform the action.
2. The method of the preceding embodiment, further comprising: receiving, from a first device storing a first cryptography-based storage application of the first user, a second request for enabling performance of the action related to the resource using the second device, wherein the request comprises the one or more access parameters, and a target address of the second cryptography-based storage application, and wherein the one or more access parameters indicate one or more limits on access to the resource; generating the access token based on the one or more access parameters, wherein the access token enables limited access to the resource of the first user; determining, based on the target address, the key associated with the second cryptography-based storage application; encrypting the access token into the encrypted payload using the key associated with the second cryptography-based storage application; generating a blockchain operation request to be executed by the blockchain node for generating the cryptographic token containing the encrypted payload; and transmitting the blockchain operation request to the blockchain node to commit to the blockchain, using an on-chain program, the cryptographic token, wherein the blockchain operation request includes the encrypted payload, and wherein the cryptographic token is assigned to the second cryptography-based storage application.
3. The method of any of the preceding embodiments, further comprising: generating a resource identifier for locating the encrypted payload, wherein the resource identifier is associated with the first cryptography-based storage application; inserting the resource identifier into the cryptographic token; and storing the encrypted payload at a location indicated by the resource identifier.
4. The method of any of the preceding embodiments, further comprising: determining an associated resource type of the cryptographic token; in response to determining that the cryptographic token is associated with a first resource type: transmitting an execution command to perform the action to a computing device corresponding to the resource; and receiving an indication of successful performance of the action; and in response to determining that the cryptographic token is associated with a second resource type, transmitting the execution command for accessing the resource to the second device, wherein the command includes one or more instructions for using the access token.
5. The method of any of the preceding embodiments, further comprising: obtaining, from the access token, the one or more access parameters; determining, based on a maximum value of a mutable parameter of the one or more access parameters, whether the second device is allowed to perform the action using the resource; and in response to determining that the second device is allowed to perform the action, modifying a value of the mutable parameter to match a corresponding value within the first request.
6. The method of any of the preceding embodiments, further comprising: obtaining, from the blockchain node, an indication of a successful blockchain operation for committing the cryptographic token to the blockchain; and transmitting, to the second device, a signal indicating the identifier of the cryptographic token.
7. The method of any of the preceding embodiments, further comprising: transmitting, to the blockchain node, a token request for data indicating one or more cryptographic tokens assigned to the second cryptography-based storage application, wherein the token request comprises an address of the second cryptography-based storage application; obtaining, from the blockchain node, the data indicating the one or more cryptographic tokens assigned to the second cryptography-based storage application; and determining that the identifier associated with the cryptographic token is included in the data indicating the one or more cryptographic tokens assigned to the second cryptography-based storage application.
8. The method of any of the preceding embodiments, wherein obtaining the encrypted payload from the blockchain node comprises: transmitting, to the blockchain node, a blockchain operation request to access the cryptographic token, wherein the blockchain operation request includes the identifier of the cryptographic token; receiving from the blockchain node, token data associated with the cryptographic token, wherein the token data comprises a resource identifier of access to the encrypted payload; and extracting the resource identifier from the cryptographic token.
9. A tangible, non-transitory, machine-readable medium storing instructions that, when executed by a data processing apparatus, cause the data processing apparatus to perform operations comprising those of any of embodiments 1-8.
10. A system comprising: one or more processors; and memory storing instructions that, when executed by the one or more processors, cause the processors to effectuate operations comprising those of any of embodiments 1-8.
11. A system comprising means for performing any of embodiments 1-8.
12. A system comprising cloud-based circuitry for performing any of embodiments 1-8.

What is claimed is:

1. A system for authorizing limited user access to resources of other users using NFTs, the system comprising:
one or more processors; and
a non-transitory, computer-readable storage medium storing instructions that, when executed by the one or more processors, cause the one or more processors to perform operations comprising:
receiving, from a first device associated with a first user storing a first cryptography-based storage application, a first request for enabling performance of one or more actions using a resource of the first user by a second device associated with a second user storing a second cryptography-based storage application, wherein the first request comprises one or more access parameters and a target address of the second cryptography-based storage application, and wherein the one or more access parameters indicate one or more limits on access to the resource;
generating an access token based on the one or more access parameters and the target address of the second cryptography-based storage application, wherein the access token enables limited access to the resource of the first user;
determining, based on the target address, a public key associated with the second cryptography-based storage application;
encrypting the access token into an encrypted payload using the public key associated with the second cryptography-based storage application;
generating a blockchain operation request to be executed by a blockchain node for generating an NFT containing the access token; and
transmitting the blockchain operation request to the blockchain node to commit, using an on-chain program, the NFT to a blockchain, wherein the blockchain operation request includes the encrypted payload, and wherein the NFT is assigned to the second cryptography-based storage application.

2. The system of claim 1, wherein the instructions cause the one or more processors to perform operations comprising:
receiving, from the second device associated with the second cryptography-based storage application, a second request for performing an action using the resource of the first user, wherein the second request comprises an address associated with the NFT;
in response to the second request, obtaining the NFT from the blockchain node;
transmitting a first command to the second device to decrypt the encrypted payload using a private key associated with the second cryptography-based storage application;
receiving the access token from the second device; and
in response to determining that metadata of the first request matches the one or more access parameters, transmitting, to a computing device associated with the resource, a second command to perform the action.

3. The system of claim 2, wherein the instructions cause the one or more processors to perform operations comprising:
obtaining, from the blockchain node, an indication of a successful blockchain operation for committing the NFT to the blockchain; and
transmitting, to the second device, a signal indicating the address associated with the NFT.

4. The system of claim 2, wherein the instructions cause the one or more processors to perform operations comprising:
transmitting, to the blockchain node, a request for data indicating one or more NFTs that are controlled by the second cryptography-based storage application, wherein the request comprises an identifier of the second cryptography-based storage application;
receiving, from the blockchain node, the data indicating the one or more NFTs controlled by the second cryptography-based storage application; and
determining that the address associated with the NFT is included in the data indicating the one or more NFTs that are controlled by the second cryptography-based storage application.

5. A method for authorizing limited user access to resources of other users using NFTs, the method comprising:
receiving, from a second device associated with a second cryptography-based storage application of a second user, a first request for performing an action using a resource associated with a first user of a first device corresponding to a first cryptography-based storage application, the first request comprising an identifier of a cryptographic token, wherein the cryptographic token is associated with an encrypted payload that stores an access token and one or more access parameters, and wherein the encrypted payload was encrypted using a key associated with the second cryptography-based storage application;
in response to the first request, obtaining the encrypted payload from a blockchain node of a blockchain;
transmitting a command to the second device to decrypt the encrypted payload using the second cryptography-based storage application, wherein the command comprises the encrypted payload;
receiving the access token and the one or more access parameters from the second device; and
in response to determining that metadata of the first request matches the one or more access parameters of the access token, transmitting a request to perform the action.

6. The method of claim 5, further comprising:
receiving, from the first device storing the first cryptography-based storage application of the first user, a second request for enabling performance of the action related to the resource using the second device, wherein the request comprises the one or more access parameters, and a target address of the second cryptography-based storage application, and wherein the one or more access parameters indicate one or more limits on access to the resource;
generating the access token based on the one or more access parameters, wherein the access token enables limited access to the resource of the first user;
determining, based on the target address, the key associated with the second cryptography-based storage application;
encrypting the access token into the encrypted payload using the key associated with the second cryptography-based storage application;
generating a blockchain operation request to be executed by the blockchain node for generating the cryptographic token containing the encrypted payload; and
transmitting the blockchain operation request to the blockchain node to commit to the blockchain, using an on-chain program, the cryptographic token, wherein the blockchain operation request includes the encrypted payload, and wherein the cryptographic token is assigned to the second cryptography-based storage application.

7. The method of claim 6, further comprising:
generating a resource identifier for locating the encrypted payload, wherein the resource identifier is associated with the first cryptography-based storage application;
inserting the resource identifier into the cryptographic token; and
storing the encrypted payload at a location indicated by the resource identifier.

8. The method of claim 5, further comprising:
determining an associated resource type of the cryptographic token;
in response to determining that the cryptographic token is associated with a first resource type:
transmitting an execution command to perform the action to a computing device corresponding to the resource; and
receiving an indication of successful performance of the action; and
in response to determining that the cryptographic token is associated with a second resource type, transmitting the execution command for accessing the resource to the second device, wherein the command includes one or more instructions for using the access token.

9. The method of claim 5, further comprising:
obtaining, from the access token, the one or more access parameters;
determining, based on a maximum value of a mutable parameter of the one or more access parameters, whether the second device is allowed to perform the action using the resource; and
in response to determining that the second device is allowed to perform the action, modifying a value of the mutable parameter to match a corresponding value within the first request.

10. The method of claim 6, further comprising:
obtaining, from the blockchain node, an indication of a successful blockchain operation for committing the cryptographic token to the blockchain; and
transmitting, to the second device, a signal indicating the identifier of the cryptographic token.

11. The method of claim 5, further comprising:
transmitting, to the blockchain node, a token request for data indicating one or more cryptographic tokens assigned to the second cryptography-based storage application, wherein the token request comprises an address of the second cryptography-based storage application;
obtaining, from the blockchain node, the data indicating the one or more cryptographic tokens assigned to the second cryptography-based storage application; and
determining that the identifier associated with the cryptographic token is included in the data indicating the one or more cryptographic tokens assigned to the second cryptography-based storage application.

12. The method of claim 5, wherein obtaining the encrypted payload from the blockchain node comprises:
transmitting, to the blockchain node, a blockchain operation request to access the cryptographic token, wherein the blockchain operation request includes the identifier of the cryptographic token;
receiving from the blockchain node, token data associated with the cryptographic token, wherein the token data comprises a resource identifier of access to the encrypted payload; and
extracting the resource identifier from the cryptographic token.

13. A non-transitory, computer-readable medium storing instructions that, when executed by one or more processors, cause the one or more processors to perform operations comprising:
receiving, from a second device associated with a second cryptography-based storage application of a second user, a first request for performing an action using a resource associated with a first user, the first request comprising an identifier of a cryptographic token associated with an encrypted payload that stores an access token and one or more access parameters;
in response to the first request, obtaining the encrypted payload from a blockchain node of a blockchain;
transmitting a command to the second device to decrypt the encrypted payload using the second cryptography-based storage application, wherein the command comprises the encrypted payload;
receiving the access token and the one or more access parameters from the second device; and
in response to determining that metadata of the first request matches the one or more access parameters of the access token, transmitting a request to perform the action.

14. The non-transitory, computer-readable medium of claim 13, wherein the instructions cause the one or more processors to perform operations comprising:
receiving, from a first device storing a first cryptography-based storage application of the first user, a second request for enabling performance of the action related to the resource using the second device, wherein the request comprises the one or more access parameters, and a target address of the second cryptography-based storage application, and wherein the one or more access parameters indicate one or more limits on access to the resource;
generating the access token based on the one or more access parameters, wherein the access token enables limited access to the resource of the first user;
determining, based on the target address, a key associated with the second cryptography-based storage application;
encrypting the access token into the encrypted payload using the key associated with the second cryptography-based storage application;
generating a blockchain operation request to be executed by the blockchain node for generating the cryptographic token containing the encrypted payload; and
transmitting the blockchain operation request to the blockchain node to commit to the blockchain, using an on-chain program, the cryptographic token, wherein the blockchain operation request includes the encrypted payload, and wherein the cryptographic token is assigned to the second cryptography-based storage application.

15. The non-transitory, computer-readable medium of claim 14, wherein the instructions cause the one or more processors to perform operations comprising:
generating a resource identifier for locating the encrypted payload, wherein the resource identifier is associated with the first cryptography-based storage application;
inserting the resource identifier into the cryptographic token; and
storing the encrypted payload at a location indicated by the resource identifier.

16. The non-transitory, computer-readable medium of claim 14, wherein the instructions cause the one or more processors to perform operations further comprising:
determining an associated resource type of the cryptographic token;
in response to determining that the cryptographic token is associated with a first resource type:
transmitting an execution command to perform the action to a computing device corresponding to the resource; and
receiving an indication of successful performance of the action; and
in response to determining that the cryptographic token is associated with a second resource type, transmitting the execution command for accessing the resource to the second device, wherein the command includes one or more instructions for using the access token.

17. The non-transitory, computer-readable medium of claim 13, wherein the instructions cause the one or more processors to perform operations comprising:
obtaining, from the access token, the one or more access parameters;
determining, based on a maximum value of a mutable parameter of the one or more access parameters, whether the second device is allowed to perform the action using the resource; and
in response to determining that the second device is allowed to perform the action, modifying a value of the mutable parameter to match a corresponding value within the first request.

18. The non-transitory, computer-readable medium of claim 14, wherein the instructions cause the one or more processors to perform operations comprising:
obtaining, from the blockchain node, an indication of a successful blockchain operation for committing the cryptographic token to the blockchain; and
transmitting, to the second device, a signal indicating the identifier of the cryptographic token.

19. The non-transitory, computer-readable medium of claim 13, wherein the instructions cause the one or more processors to perform operations comprising:
transmitting, to the blockchain node, a token request for data indicating one or more cryptographic tokens assigned to the second cryptography-based storage application, wherein the token request comprises an address of the second cryptography-based storage application;
obtaining, from the blockchain node, the data indicating the one or more cryptographic tokens assigned to the second cryptography-based storage application; and
determining that the identifier of the cryptographic token is included in the data indicating the one or more cryptographic tokens assigned to the second cryptography-based storage application.

20. The non-transitory, computer-readable medium of claim 13, wherein the instructions cause the one or more processors to perform operations comprising:
transmitting, to the blockchain node, a blockchain operation request to access the cryptographic token, wherein the blockchain operation request includes the identifier of the cryptographic token;
receiving from the blockchain node, token data associated with the cryptographic token, wherein the token data comprises a resource identifier of access to the encrypted payload; and
extracting the resource identifier from the cryptographic token.
